(19) United States
(12) Patent Application Publication
(10) Pub. No.: US 2009/0315409 A1
(43) Pub. Date: Dec. 24, 2009

(54) SAFETY SOCKET

(75) Inventors: William R. Wheeler, Taipei Hsien (TW); Chien-Long Lin, Taipei Hsien (TW); Shiann-Chang Yeh, Taipei Hsien (TW); Chien-Hong Lin, Taipei Hsien (TW); Che-Cheng Chang, Taipei Hsien (TW)

Correspondence Address: RABIN & Berdo, PC, 1101 14TH STREET, NW, SUITE 500, WASHINGTON, DC, 20005, US

(73) Assignee: ACBEL POLYTECH INC., Taipei Hsien (TW)

(21) Appl. No.: 12/362,024

(22) Filed: Jan. 29, 2009

(30) Foreign Application Priority Data
Jun. 24, 2008 (TW) 097123477

(51) Int. Cl. H02H 3/40

(52) U.S. Cl. 307/126

(57) ABSTRACT

A digital automatic monitoring and power breaking safety socket has a shell in which an electrical connection base is mounted for connecting to a power line and an external line plug inside. A power switch is connected in series between the electrical connection base and the power line. A digital power monitoring circuit is coupled to the power line detect the power status to control the power switch based on the power status. Further, a power line data communication circuit is mounted in the shell and connects to the digital power monitoring circuit to obtain and process the power status. The processed power status is loaded into the power line that connects to the electrical connection base. Therefore, in addition to automatic power breaking and supplying, a remote power management host is able to obtain the power status and remotely control the socket.

### BACKGROUND OF THE INVENTION

1. Field of the Invention

The invention relates to a socket and, in particular, to a safety socket that uses the digital monitoring technique to achieve automatic power breaking and supply.

2. Description of Related Art

Electrical sockets have different styles according to their usages. But they are all used as power terminal elements for AC power or power supplying devices. An electronic device obtains its working power after its power plug is plugged into the socket.

Taking an indoor wall-embedding socket as an example, the socket is embedded in a wall and connects to a pre-embedded power line in the wall. The electricity safety is monitored by a power breaker of the building. When the total power used in the building exceeds a safety threshold, the power breaker automatically breaks the circuit, cutting power to all the sockets in the building. The breaker is restarted after the total power usage drops below the safety threshold. However, a common reason that the total power exceeds the safety threshold is because too many high-power consumption electronic products are used at the same time. Therefore, once the power is overloaded, the breaker cuts the power of all sockets. It is very inconvenient.

Take the socket of a power distributor as another example. A distributive power supply has a plurality of breakers, a plurality of sockets, and a power management module inside a shell. In particular, the breakers are all connected between the external power line and the corresponding sockets in order to distribute power of the external power line to the sockets. The power management module includes a network port or a serial port for storing the power status of the power distributor and for a remote or a local monitoring computer connected to the network port or serial port to conveniently obtain the power status thereof for management. Although currently the power distributor is built in with a power management module, data transmission of the power management module still adopts a network protocol or simple serial protocol. Therefore, the monitoring computer still requires related network settings and network line deployment.

### SUMMARY OF THE INVENTION

In view of the foregoing, an objective of the invention is to provide a digital automatic monitoring and power breaking safety socket. The safety socket directly monitors the power status of the power line connected to the socket. If the electrical current overflows or the power is overloaded, the safety socket immediately breaks the electrical connection between the socket and the power line.

To achieve the above-mentioned objective, the disclosed digital automatic monitoring and power breaking safety socket has:

The socket has a shell in which an electrical connection base is mounted for connecting to a power line and an external line plug inside. A power switch is connected in series between the electrical connection base and the power line. A digital power monitoring circuit is coupled to the power line detect the power status to control the power switch based on the power status. Further, a power line data communication circuit is mounted in the shell and connects to the digital power monitoring circuit to obtain and process the power status. The processed power status is loaded into the power line that connects to the electrical connection base. Therefore, in addition to automatic power breaking and supplying, a remote power management host is able to obtain the power status and remotely control the socket.

According to the invention, the socket is disposed with a digital power monitoring circuit and a power switch to directly monitor whether the socket overflows or is overloaded. If so, the power switch is controlled to break the connection between the electrical connection base and the power line. After the digital power monitoring circuit determines that the current power status returns to its safe range, the power switch is driven to close so that the socket resumes power supply. For a remote power management host to conveniently obtain the power status of each socket, the invention further electrically connects the power line data communication circuit to the digital power monitoring circuit. The obtained power status is processed and coupled to the power line connected with the electrical connection base. The power status information is transmitted out via the power line. Therefore, the remote power management host can obtain the power status data of the sockets through the power line. Remote power management is thus achieved without using other network lines or serial lines.

Another objective of the invention is to provide a socket whose on and off is remotely controlled. Since the above-mentioned power line data communication circuit has network packets conveyed on the power line, the remote power management host can process the on/off command that controls the power switch in a specific socket and load it into the power line. After the power line data communication circuit in the socket obtains the on/off command packet from the power line, this on/off command is transmitted to the digital power monitoring circuit. The digital power monitoring circuit follows the on/off command to control the on and off of the power switch. This achieves the goal of remotely controlling power.

### BRIEF DESCRIPTION OF THE DRAWINGS

FIG. 1 is a perspective view of a socket according to a preferred embodiment of the invention;

FIG. 2 is a schematic view of the internal structure of the socket of FIG. 1;

FIG. 3 is a block diagram of a circuit in the socket;

FIG. 4 is a detailed circuit diagram of part of FIG. 3;

FIG. 5 is a perspective view of part of a power distributor;

FIG. 6 is a circuit block diagram in a single socket of FIG. 5; and

FIG. 7 is a schematic view showing a plurality of power distributors connecting to a remote power management host.

### DETAILED DESCRIPTION OF THE PREFERRED EMBODIMENT

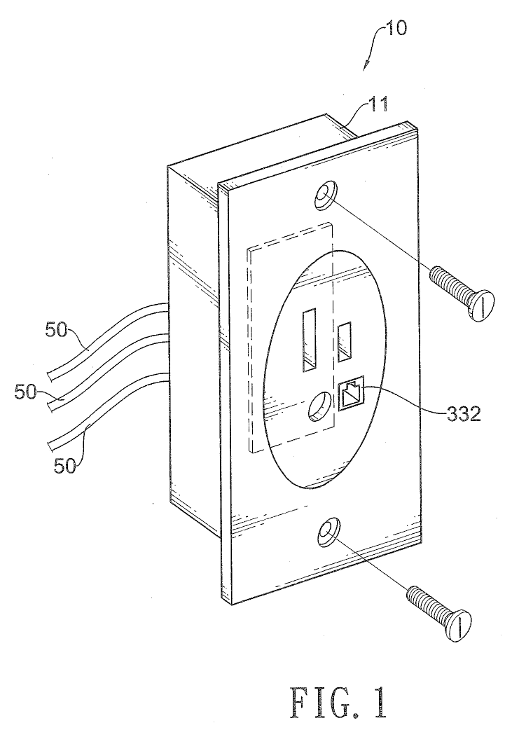

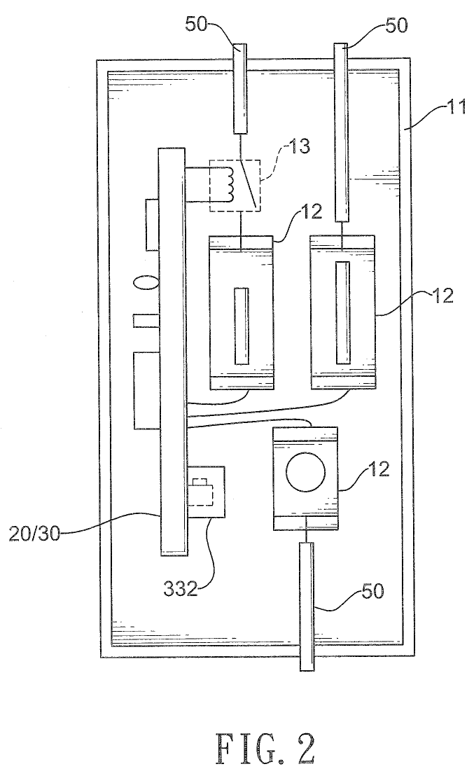

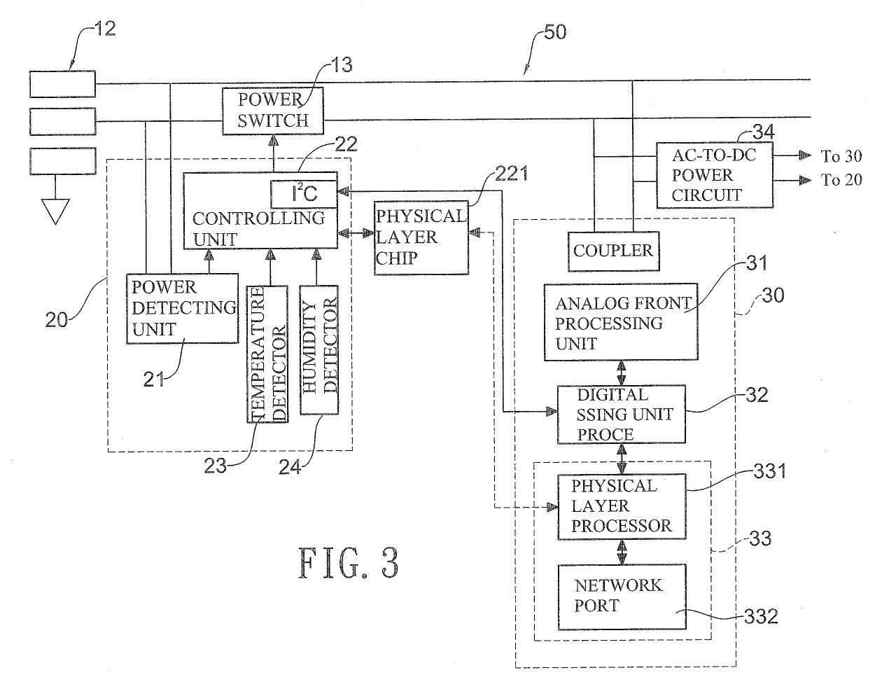

With reference to FIGS. 1 to 3 for a preferred embodiment of the invention, a socket 10 is a wall-embedded socket. The socket 10 comprises a shell 11, a power switch 13, a digital power monitoring circuit 20 and a power line data communication circuit 30.

The shell 11 has an electrical connection base 12 therein for a power line to connect and an external line plug to plug in.

The power switch 13 is connected in series between the electrical connection base 12 and the power line 50. In this embodiment, the power switch can be an electro-mechanical relay or a solid-state relay (SSR).

The digital power monitoring circuit 20 is mounted in the shell 11 and electrically connected to the electrical connection base 12 for obtaining power status. The digital power monitoring circuit 20 is electrically connected with a trigger terminal (e.g., a magnetic coil of the electro-mechanical relay) of the power switch 13, thereby controlling the on and off of the power switch 13.

The power line data communication circuit 30 is mounted in the shell 11 and coupled with the electrical connection base 12. The power line data communication circuit 30 is electrically connected with the digital power monitoring circuit 20 to obtain the power status. The power line data communication circuit 30 processes the power status and couples it to the power line 50 connected with the electrical connection base 12.

The digital power monitoring circuit 20 has a power detecting unit 21 and a controlling unit 22 and may further comprises a temperature detector 23 and a humidity detector 24.

The power detecting unit 21 is coupled to the electrical connection base to detect the power status of the power line 50 currently connected with the electrical connection base 12. The power status includes the information of voltage, current and power.

The controlling unit 22 is electrically connected between the power detecting unit 21 and the power switch 13. The controlling unit 22 mainly includes a microprocessor, a field programmable gate array (FPGA) or a single chip (e.g., the PIC series of Microchip Corp.). The controlling unit 22 converts the power status detected by the power detecting unit 21 to the corresponding power status data for a comparison with predetermined power safety threshold values.

The controlling unit 22 compares the power status data with the predetermined power safety threshold values. If an abnormal power status is detected, the power switch 13 is turned off. After the power status is determined to become normal again, the power switch 13 is turned on. The digital power monitoring circuit 20 can further comprise the temperature detector 23 or the humidity detector 24 connected with their respective driving circuits for sending the internal temperature or humidity of each socket 10 to the controlling unit 22.

The power line data communication circuit 30 comprises an analog front processing unit 31, a digital processing unit 32, a network packet processing unit and an AC-to-DC power circuit 34.

The analog front processing unit 31 is coupled to the electrical connection base 12 via a coupler. The digital processing unit 32 is electrically connected with the analog front processing unit 31 and the controlling unit 22 to obtain the power status, temperature and humidity. In this embodiment, the digital processing unit 32 has a GPSI or I²C interface for connecting to a microprocessor, FPGA or PIC single chip controlling unit 22 with the same interface, thereby perform bi-directional data transmissions.

The network packet processing unit 33 mainly includes a physical layer processor 331 and a network port 332. The physical layer processor 331 connects to the digital processing unit 32 and the network port 332 (RJ45).

The AC-to-DC power circuit 34 is electrically connected to the power connection base 12 to obtain the AC power from the power line 50. The AC-to-DC power circuit 34 converts the AC power into DC power as the operating power for the above-mentioned circuits and units. The AC-to-DC power circuit can be a switch type power circuit.

In the power line data communication circuit 30 of the invention, the digital processing unit 32 connects to the controlling unit 22 of the digital power monitoring circuit 20 to obtain the current power status of the power line 50. The power status is processed and modulated by the analog front processing unit Afterwards, the modulated power status is coupled to the power line 50 and sent out. Moreover, the controlling unit 22 can be connected to the physical layer processor 331 through a physical layer chip 221. After the physical layer processor 331 receives the power status, the power status is further transmitted to the digital processing unit 32. Besides, the digital processing unit 32 can also obtain the network packet of on/off command from a remote power management host. After demodulation of the network packet, the digital processing unit 32 extracts the on/off command and outputs the command to the controlling unit 22. The controlling unit 22 turns on or turns off the power switch 13 based on the received command, achieving the goal of remote control.

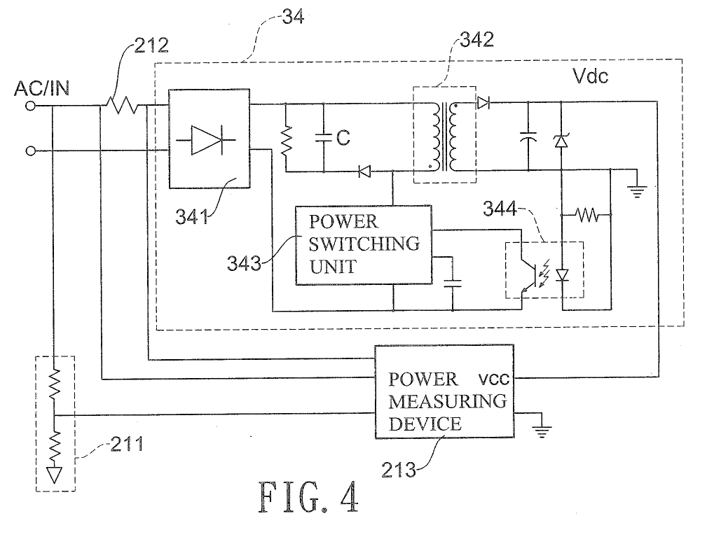

With reference to FIG. 4, the circuit diagram of the AC-to-DC power circuit 34 and the power detecting unit 21 is shown. The AC-to-DC power circuit comprise a full-wave rectifier 341, a transformer and a power switching unit 343.

The full-wave rectifier 341 connects to the power connection base 12 to obtain the AC power. After the full-wave AC power is rectified to DC power, the DC power is output through a filter capacitor C.

In the transformer, its primary side connects to the filter capacitor C. The secondary side is the DC power output terminal Vdc of the AC-to-DC power circuit 34. The DC power is output to the digital power monitoring circuit 20 and the power line data communication circuit 30.

The power switching unit 343 connects to the output terminal Vdc via a photo coupler 344. The electrical current on the primary side of the transformer is adjusted according to the voltage of the DC power, thereby providing a stable DC voltage.

The power detecting unit 21 includes a voltage divider 211, a current detecting resistor 212 and a power measuring device 213. The power measuring device 213 connects to the power connection base 12 via the voltage divider 211 to obtain the voltage on the power line 50. The current detecting resistor 212 is connected in series between the power connection base 12 and the power line. Thus, the power measuring device 213 obtains the electrical current on the power line via the current detecting resistor 212. The power measuring device 213 connects to the controlling unit 22 in order to transmit voltage, electrical current and power statuses to the controlling device 22.

According to the above description, the invention has the digital power monitoring circuit 20 and the power switch 13 in the socket in order to monitor whether the socket has over-current or overloading situation. If the situation happens, the power switch 13 is controlled to break the connection between the power connection base 12 and the power line 50. After the digital power monitoring circuit 20 determines that the current power status returns to the safe range, the power switch 13 is driven to close and resumes power supply to the socket 10.

In order for the remote power management host to obtain the power status of each socket 10, the power line data communication circuit 30 is electrically connected with the digital power monitoring circuit 20. The obtained power status data are processed and loaded to the power line 50 connected with the power connection base 12, thereby transmitting the data out. Consequently, the remote power management host can obtain the power status data of a plurality of sockets 10 via the power line 50. It does not need the installation of other network lines or serial lines for the remote power management.

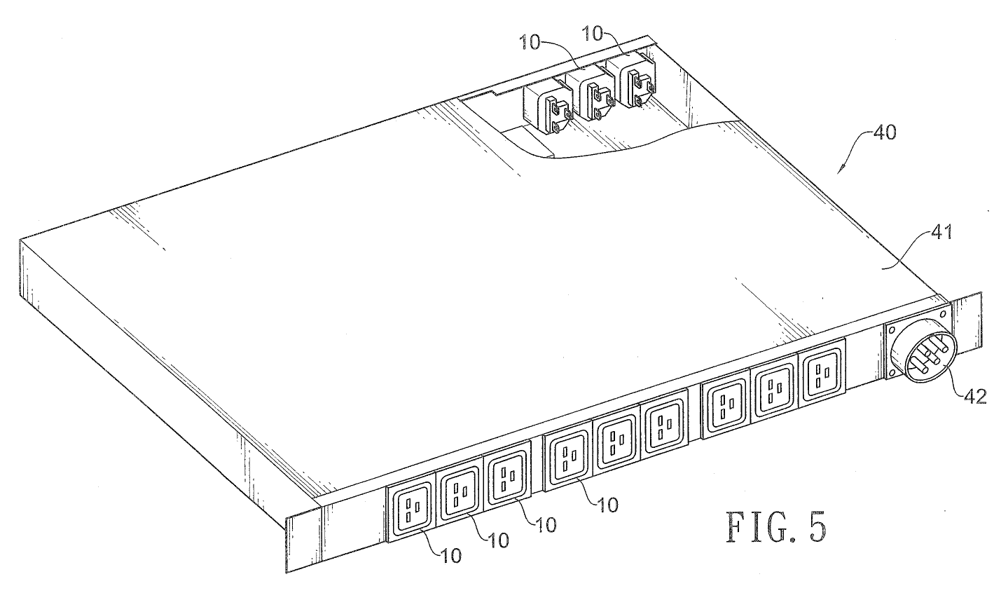

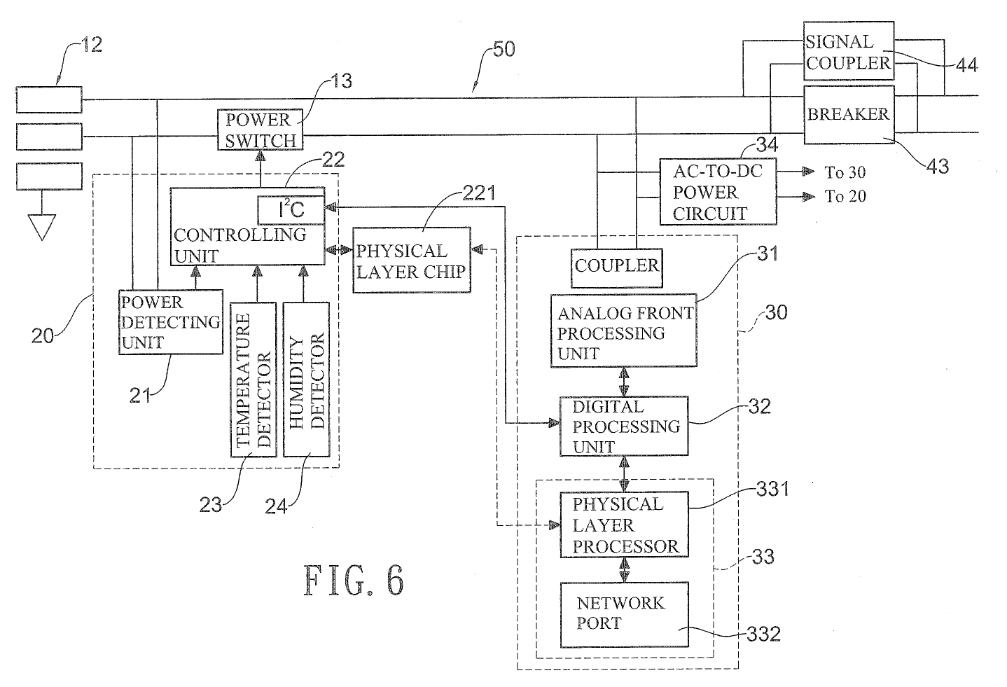

With reference to FIG. 5 for a second embodiment of the invention, the socket 10 is used in a power distributor 40. The power distributor 40 comprises a box 41 having a plurality of sockets 10 and a plurality of breakers. Each of the sockets 10 is exposed on the box 41. The box 41 has an external power line 42. The power distributor 40 utilizes the above-mentioned sockets 10. With reference to FIG. 6, the power connection base 12 is connected with a corresponding breaker 43. The breakers 43 are then connected to the external power line 42 to obtain AC power. Since the power distributor 40 usually provides stable power to the servers in a control room, the power distributor 40 has to have the function of power management. Each of the breakers 43 is connected in parallel with a signal coupler 44, so that the power status data can still be transmitted out via the signal coupler 44 when the power is being switched.

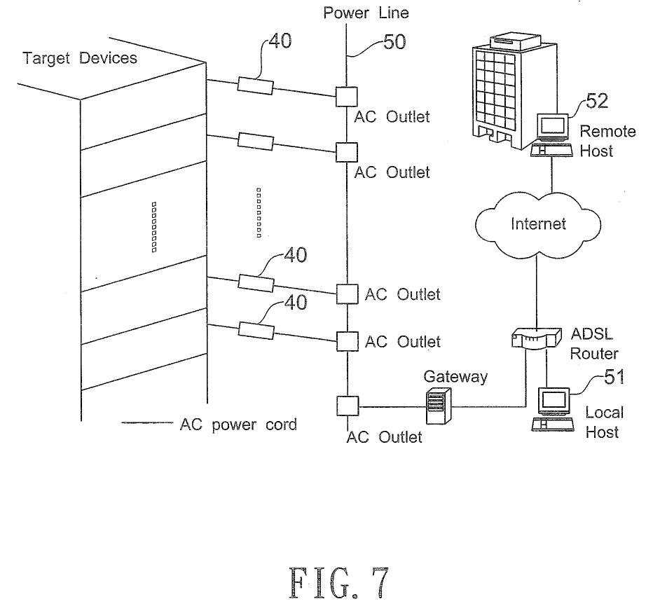

With reference to FIG. 7, the power distributor 40 uses socket 10 in accordance with the present invention. Therefore, each of the sockets 10 can transmit its power status via the power line. Each power distributor 40 can thus link to a local power line host 51 via a power line 50. The local power line host then links to a remote power management host 52 via the Internet. Likewise, the power line data communication circuit 30 of each socket 10 in each power distributor 40 can retrieve network packets from the power line. Therefore, the remote power management host 52 can send the network packet of an on/off command to a specific socket 10 of a particular power distributor 40, achieving the goal of remote power control.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A digital automatic monitoring and power breaking safety socket, comprising:
a shell in which a power connection base is mounted for connection of a power line and insertion of an external plug;
a power switch connected in series between the power connection base and the power line;
a digital power monitoring circuit mounted in the shell, coupled to the power connection base to obtain its power status, and electrically connected with a trigger terminal of the power switch for turning on and turning off of the power switch;
a power line data communication circuit mounted in the shell, coupled to the power connection base, and electrically connected with the digital power monitoring circuit to obtain and process the power status, and load the power status to the power line connected with the power connection base; and
an AC-to-DC power circuit electrically connected to the power connection base to obtain AC power from the power line and converts the AC power into DC power for the digital power monitoring circuit and the power line data communication circuit.

2. The digital automatic monitoring and power breaking safety socket as claimed in claim 1, wherein the digital power monitoring circuit comprises:
a power detecting unit coupled to the power connection base to detect the power status of the power line connected with the power connection base, the power status comprising voltage, current and power data; and
a controlling unit electrically connected between the power detecting unit and the power switch to convert the power status detected by the power detecting unit to corresponding power status data to be compared with predetermined power safety values.

3. The digital automatic monitoring and power breaking safety socket as claimed in claim 2, wherein the controlling unit further connects to a temperature detector and a humidity detector to sense temperature and humidity inside the shell.

4. The digital automatic monitoring and power breaking safety socket as claimed in claim 2, wherein the controlling unit comprises a microprocessor, a field programmable gate array or a single chip.

5. The digital automatic monitoring and power breaking safety socket as claimed in claim 3, wherein the controlling unit comprises a microprocessor, a field programmable gate array or a single chip.

6. The digital automatic monitoring and power breaking safety socket as claimed in claim 4, the power detecting unit comprises
a power measuring device connected to the power connection base through a voltage divider to obtain the voltage on the power line;
a current detecting resistor connected in series between the power connection base and the power line so that the power measuring device obtains the electrical current on the power line from the current detecting resistor; and
the power measuring device being connected to the controlling unit to transmit the voltage and current data to the controlling unit.

7. The digital automatic monitoring and power breaking safety socket as claimed in claim 5, the power detecting unit comprises
a power measuring device connected to the power connection base through a voltage divider to obtain the voltage on the power line;
a current detecting resistor connected in series between the power connection base and the power line so that the power measuring device obtains the electrical current on the power line from the current detecting resistor; and
the power measuring device being connected to the controlling unit to transmit the voltage and current data to the controlling unit.

8. The digital automatic monitoring and power breaking safety socket as claimed in claim 2, wherein the power line data communication circuit comprises
an analog front processing unit coupled to the power connection base through a coupler; and
a digital processing unit electrically connected to the analog front processing unit and connected with the controlling unit of the digital power monitoring circuit to obtain power status.

9. The digital automatic monitoring and power breaking safety socket as claimed in claim 8, wherein the power line data communication circuit further includes
a network packet processing unit comprising a physical layer processor and a network port exposed on the shell, with the physical layer processor connecting to the digital processing unit and the network port.

10. The digital automatic monitoring and power breaking safety socket as claimed in claim 2, wherein the power line data communication circuit further includes
a network packet processing unit comprising a physical layer processor and a network port exposed on the shell;
the physical layer processor connecting to the digital processing unit, the network port, and the controlling unit so that the power status are processed by the digital processing unit and then sent out.

11. The digital automatic monitoring and power breaking safety socket as claimed in claim 8, wherein the controlling unit and the digital processing unit have a GPSI or I2C interface, respectively, and the network port is RJ45.

12. The digital automatic monitoring and power breaking safety socket as claimed in claim 9, wherein the controlling unit and the digital processing unit have a GPSI or I2C interface, respectively, and the network port is RJ45.

13. The digital automatic monitoring and power breaking safety socket as claimed in claim 10, wherein the controlling unit further includes a physical layer chip connected to the physical layer processor.

14. The digital automatic monitoring and power breaking safety socket as claimed in claim 8, wherein the AC-to-DC power circuit comprises:
a full-wave rectifier connected to the power connection base to obtain and rectify the AC power and outputting DC power through a filter capacitor;
a transformer having a primary side connected to the filter capacitor and a secondary side as the DC power output terminal of the AC-to-DC power circuit, and providing DC power to the digital power monitoring circuit and the power line data communication circuit; and
a power switching unit connected to the DC power output terminal via a photo coupler, adjusting a magnitude of a current on the primary side of the transformer according to the DC power, and outputting DC power with a stable voltage.

15. The digital automatic monitoring and power breaking safety socket as claimed in claim 9, wherein the AC-to-DC power circuit comprises:
a full-wave rectifier connected to the power connection base to obtain and rectify the AC power and outputting DC power through a filter capacitor;
a transformer having a primary side connected to the filter capacitor and a secondary side as the DC power output terminal of the AC-to-DC power circuit, and providing DC power to the digital power monitoring circuit and the power line data communication circuit; and
a power switching unit connected to the DC power output terminal via a photo coupler, adjusting a magnitude of a current on the primary side of the transformer according to the DC power, and outputting DC power with a stable voltage.

16. The digital automatic monitoring and power breaking safety socket as claimed in claim 10, wherein the AC-to-DC power circuit comprises:
a full-wave rectifier connected to the power connection base to obtain and rectify the AC power and outputting DC power through a filter capacitor;
a transformer having a primary side connected to the filter capacitor and a secondary side as the DC power output terminal of the AC-to-DC power circuit, and providing DC power to the digital power monitoring circuit and the power line data communication circuit; and
a power switching unit connected to the DC power output terminal via a photo coupler, adjusting a magnitude of a current on the primary side of the transformer according to the DC power, and outputting DC power with a stable voltage.

17. The digital automatic monitoring and power breaking safety socket as claimed in claim 1, wherein the power switch is an electro-mechanical relay or a solid-state relay.

18. A power distributor comprising:
a box connected with an external power line;
a plurality of breakers mounted in the box and connected with the external power line, wherein each of the breakers is connected in parallel with a signal coupler; and
a plurality of sockets each of which is connected with a corresponding breaker and mounted on the box, wherein each of the socket comprises:
a shell in which a power connection base is mounted for connection of a power line and insertion of an external plug;
a power switch connected in series between the power connection base and the power line;
a digital power monitoring circuit mounted in the shell, coupled to the power connection base to obtain its power status, and electrically connected with a trigger terminal of the power switch for turning on and turning off of the power switch;
a power line data communication circuit mounted in the shell, coupled to the power connection base, and electrically connected with the digital power monitoring circuit to obtain and process the power status, and load the power status to the power line connected with the power connection base; and
an AC-to-DC power circuit electrically connected to the power connection base to obtain AC power from the power line and converts the AC power into DC power for the digital power monitoring circuit and the power line data communication circuit.

19. The power distributor as claimed in claim 18, wherein the digital power monitoring circuit comprises:
a power detecting unit coupled to the power connection base to detect the power status of the power line connected with the power connection base, the power status comprising voltage, current and power data; and
a controlling unit electrically connected between the power detecting unit and the power switch to convert the power status detected by the power detecting unit to corresponding power status data to be compared with predetermined power safety values.

20. The power distributor as claimed in claim 19, wherein the power line data communication circuit comprises
an analog front processing unit coupled to the power connection base through a coupler;
a digital processing unit electrically connected to the analog front processing unit and connected with the controlling unit of the digital power monitoring circuit to obtain power status; and
a network packet processing unit comprising a physical layer processor and a network port exposed on the shell, with the physical layer processor connecting to the digital processing unit and the network port.
